(19) United States
(12) Patent Application Publication
(10) Pub. No.: US 2008/0304390 A1
(43) Pub. Date: Dec. 11, 2008

(54) DATA RECORDER

(75) Inventors: Hirofumi Hari, Kodaira-shi (JP); Hirotoshi Shimada, Ome-shi (JP)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: TEAC CORPORATION, Tokyo (JP)

(21) Appl. No.: 12/056,200

(22) Filed: Mar. 26, 2008

(30) Foreign Application Priority Data
Jun. 6, 2007 (JP) 2007-150190

(51) Int. Cl. G11B 5/027; H04N 7/26

(52) U.S. Cl. 369/85; 386/124; 386/E05.001

(57) ABSTRACT

A data recorder has a built-in medium recorder and a portable medium recorder. The data recorder has an optical disk drive section and a HDD section. In addition to having a mode for recording data in either of the mediums, the data recorder has a mode for simultaneously recording data in both the mediums. A pair of directories in an HD and an optical disk, where data are to be recorded, is stored as relevance information in the HD. In the case of second simultaneous recording or subsequent simultaneous recording, a reference is made to the relevance information, thereby automating location of directories where data are to be recorded simultaneously and obviating selecting operation.

### PRIORITY INFORMATION

This application claims priority to Japanese Patent Application No. 2007-150190 filed on Jun. 6, 2007, which is incorporated herein by reference in its entirety.

### BACKGROUND

1. Technical Field

The present invention relates to a data recorder, and more particularly to simultaneous recording performed by a built-in medium recorder, such as a hard disk drive (HDD), and a data recorder equipped with a portable medium recorder, such as an optical disk drive.

2. Related Art

A DVD recorder equipped with a hard disk drive (HDD) and a DVD drive has already been known, and recording of a TV program, or the like, into a hard disk (HD) or a DVD or duplicating of the program to the DVD after recording of the program into the HD are feasible. However, such a DVD recorder is basically intended for recording data into either the HD or the DVD and not for recording data both into the HD and the DVD simultaneously. Although simultaneous recording of different sets of data into the HD and the DVD by use of a plurality of tuners has already been proposed, this technique is not intended for simultaneously recording an identical set of data into the HD and the DVD.

In the meantime, a technique for recording an identical set of data into a plurality of HDs has already been known in the field of a file server, or the like, in order to enhance reliability. However, the technique is for recording data into one HD and subsequently recording the same data into another HD for backup purpose and not for simultaneously recording an identical set of data into a plurality of recording mediums.

An attempt can be made to enhance reliability and convenience, so long as simultaneous recording of an identical set of data into a stationary medium, such as a HD, and a portable medium, such as a DVD, is possible. Specifically, a probability that recording of data will end in a failure for reasons of flaws in a recording surface, deterioration, or the like, is not zero for the HD and the DVD. However, the probability of occurrence of a failure can be reduced as closely to 0% as possible by means of simultaneous recording. Further, although the HDDs include a removable HDD, the majority of the HDDs are built-in type (or stationary type). Record data need to be copied to an inexpensive removable medium, such as a DVD, in order to distribute the record data to another person. In this case, copying operation to be performed after recording can be obviated by means of simultaneously recording data into the HD and the DVD beforehand. Alternatively, even when distribution of record data to another person is the principal objective, mere recording of data into a DVD may end in a failure. For this reason, there is also a case where simultaneous recording of data into both the DVD and the HD is desirable.

As mentioned above, simultaneous recording yields an advantage. However, in order to simultaneously record data into the HD and the DVD, a directory that is a location where data are to be recorded must be designated in the HD and the DVD, respectively. Designating a directory where data are to be recorded in each of the HD and the DVD before or after setting of a simultaneous recording mode is performed as occasion arises is intricate, and also an error can arise in setting of the directory.

As a matter of course, there is a conceivable method for creating the same number of directories of the same name in the HD and the DVD, respectively, and simultaneously recording data by means of automatically designating corresponding directories. However, it may be the case where some users will desire to give an arbitrary name to a directory of the HD or the DVD. Moreover, there may also arise a case where directories in the HD may change in number from directories in the DVD when a certain set of data is simultaneously recorded but another set of data is recorded solely in the HD and not in the DVD because the importance of the data is comparatively low and there is no schedule for distributing the data to other persons. Further, there is a case where data are recorded in a DVD distributed from another person. In this case, the number of directories that are originally present in a DVD may change arbitrarily. Consequently, when data are simultaneously recorded in a portable medium, such as a DVD, as well as in a HD, there are many cases where a correspondence between the directories in the HD and the directories in the DVD is uncertain.

### SUMMARY

The present invention provides an apparatus capable of simultaneously, efficiently recording an identical set of data in a built-in medium (or a stationary medium), such as a HD, and a portable medium, such as a DVD.

The present invention is directed toward a data recorder comprising a built-in medium recorder; a portable medium recorder; a control section that has an individual recording mode for independently recording data in the built-in medium and the portable medium and a simultaneous recording mode for simultaneously recording identical data in the built-in medium and the portable medium and that controls the built-in medium recorder and the portable medium recorder in such a way that data are recorded in either of the modes in accordance with a selection instruction; and a storage section that stores relevance information for associating with each other, among areas in the built-in medium and areas in the portable medium, areas where data are to be recorded simultaneously. When the simultaneous recording mode is instructed, the control section locates areas in the built-in medium and the portable medium where data are to be simultaneously recorded, by use of the relevance information stored in the storage section and controls the built-in medium recorder and the portable medium recorder so as to simultaneously record data in the thus-located areas.

The present invention is also directed toward a data recorder comprising a hard disk drive that records data in a hard disk; an optical disk drive that records data in an optical disk; and a control section that controls the hard disk drive and the optical disk drive so as to simultaneously record data in the hard disk and the optical disk. When second simultaneous recording or subsequent simultaneous recording for the hard disk and the optical disk is performed, the control section automatically sets an area in the hard disk and an area in the optical disk where data are to be recorded simultaneously, by use of relevance information that associates the area in the hard disk with the area in the optical disk and that has been selected at the time of performance of first simultaneous recording for the hard disk and the optical disk.

According to the present invention, the same set of data can be simultaneously, efficiently recorded in a built-in medium and a portable medium.

The invention will be more clearly comprehended by reference to the embodiment provided below. However, the following embodiment is merely illustrative, and the scope of the invention is not limited to the embodiment.

### BRIEF DESCRIPTION OF THE DRAWINGS

A preferred embodiment of the present invention will be described in detail by reference to the following drawings, wherein:

FIG. 1 is a block diagram of an overall data recorder;

FIG. 2 is a structural diagram of directories in a HD and a DVD;

FIG. 3 is a processing flowchart (Part 1) of an embodiment;

FIG. 4 is a processing flowchart (Part 2) of the embodiment;

FIG. 5 is a processing flowchart (Part 3) of the embodiment; and

FIG. 6 is a descriptive view of paired project information (relevant information).

### DETAILED DESCRIPTION

An embodiment of the present invention will be described by reference to the drawings.

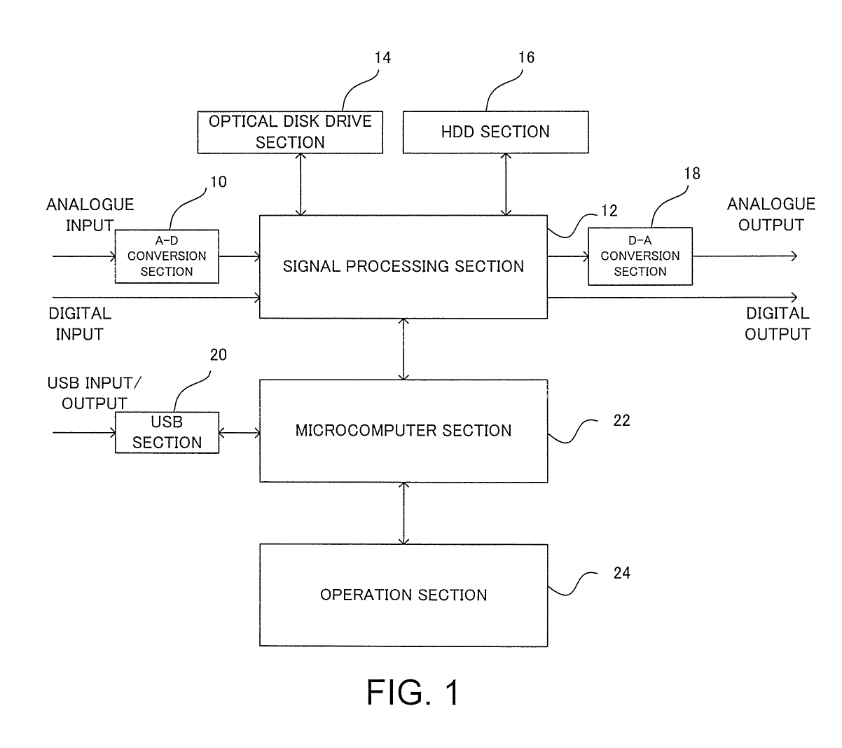

FIG. 1 shows the configuration of an overall data recorder of an embodiment of the present invention. The data recorder is an audio data recorder for recording audio data.

In FIG. 1, an analogue audio signal that is an object of recording is input from an analogue input terminal of an A-D converter 10. The thus-input analogue audio signal is converted into a digital audio signal at a predetermined sampling frequency and in a predetermined number of bits, and the digital audio signal is output to a signal processing section 12. Moreover, in addition to the analogue audio signal, a digital audio signal can also be input by way of a digital input terminal. The digital audio signal is supplied to a signal processing section 12 without flowing through the A-D converter 10.

An optical disk drive section 14 is a portable medium recorder; namely, a so-called DVD recorder. The optical disk drive section 14 is connected to the signal processing section 12 and records into a DVD the audio signal output from the signal processing section 12. The optical disk drive section 14 also reproduces audio data recorded in a DVD, and outputs the thus-reproduced data to the signal processing section 12.

An HDD section 16 is a built-in medium recorder and is connected to the signal processing section 12. The HDD section 16 records the audio signal output from the signal processing section 12 into a HD. Further, the HDD section 16 reproduces audio data recorded in the HD and outputs the thus-reproduced data to the signal processing section 12.

A D-A converter 18 converts a digital audio signal output from the signal processing section 12 into an analogue audio signal and outputs the thus-converted audio signal to equipment disposed outside, such as an amplifier.

The signal processing section 12 is made up of a DSP (digital signal processor), and the like. Alternatively, the signal processing section 12 subjects a digital audio signal output from the A-D converter 10 or a digital audio signal output directly from the digital input terminal to digital signal processing, such as filtering; and outputs a digital audio signal in a BWF (Broadcast Wave Format) to the optical disk drive section 14 and the HDD section 16. The signal processing section 12 outputs the digital audio signal output from the optical disk drive section 14 or the HDD section 16 to the D-A converter 18. In accordance with an instruction from a microcomputer section 22, the signal processing section 12 transfers the digital audio signal output from the optical disk drive section 14 to the HDD section 16 or transfers the digital audio signal output from the HDD section 16 to the optical disk drive section 14. The former corresponds to processing performed when a digital audio signal is copied from the optical disk drive section 14 to the HDD section 16, and the latter corresponds to processing performed when a digital audio signal is copied from the HDD section 16 to the optical disk drive section 14.

An operation section 24 has various buttons, such as a record button, a play button, and stop button, or various switches provided in a front panel of a main unit of the audio data recorder, and the user inputs an instruction by means of operating the buttons or switches. The operation section 24 outputs a command complying with the instruction made by the user to the microcomputer section 22. The microcomputer section 22 outputs an instruction complying with the command to the signal processing section 12, thereby controlling operation of the signal processing section 12; namely, operation of the optical disk drive section 14 and operation of the HDD section 16. The microcomputer section 22 outputs internal information to the operation section 24. The operation section 24 displays the internal information by means of an LED, an LCD, and the like, provided in the front panel. The internal information represents the status of the optical disk drive section 14 and that of the HDD section 16; for example, information about a current drive (a drive that is currently active or serves as the main drive), the statuses of directories in respective drives, and the like.

The microcomputer section 22 controls operation of the signal processing section 12 in accordance with an operation signal from the operation section 24, thereby controlling recording/reproduction of data performed by the optical disk drive section 14 and the HDD section 16. The microcomputer section 22 is connected to an USB interface section 20 and becomes able to perform inputting or outputting of data from or to an external device. When the audio data recorder is connected to; for example, a personal computer, the HD of the HDD section 16 is perceived as an external disk drive of the personal computer, and a file can be transferred between the personal computer and the HDD.

The audio data recorder of the present embodiment has at least two recording modes. The first mode is an individual recording mode; that is, a mode for recording digital audio data to the HD or the DVD. When digital audio data are recorded in the HD, the signal processing section 12 outputs a digital audio signal solely to the HDD section 16, and the HDD section 16 records the digital audio signal to the HD. When the digital audio signal is recorded in the DVD, the signal processing section 12 outputs the digital audio signal solely to the optical disk drive section 14, and the optical disk drive section 14 records the digital audio signal into the DVD. In accordance with an operation signal from the operation section 24, the microcomputer section 22 determines which one of the HD or the DVD as a location where the digital audio signal is to be recorded, and issues an instruction pertaining to a result of determination to the signal processing section 12. Specifically, the user first selects a drive that serves as a target of recording or reproduction by means of an operation button on the operation section 24. The selected drive is a current drive. In a default state, the HDD section 16 may also be taken as a current drive. When the HDD section 16 is taken as a current drive, the user next operates a record button of the operation section 24, whereupon music is input as an audio signal to the signal processing section 12. When recording operation is stopped by means of the user operating a stop button of the operation section 24, a file is created in the BWF in the HD, and the file is managed by means of a project. The project is an aggregation of pieces of playback information (a playlist) in which pieces of music to be reproduced are collected; namely, a kind of directory. The project is made up of directories where pieces of music are recorded under the same recording conditions (a sampling frequency, a quantization bit, and the like) Directories; namely, project directories, are created in the HD, and files of the BWF, playlist files, mark list files, project files, and the like, are stored in the directories. When certain music A is recorded under recording conditions A and when another music B is recorded under another recording conditions, the music A and the music B are managed as different projects. When recorded music is played back, the user selects a file to be reproduced by means of the LCD of the operation section 24 and operates the play button.

The same also applies to a case where music is recorded in a DVD. The user selects the optical disk drive section 14 as a current drive by operating the operation section 24. Next, the record button is operated, whereby the music is stored as a file of BWF into the project directory of the DVD.

The second mode is a simultaneous recording mode. In the simultaneous recording mode, a single piece of music is recorded into the HD and simultaneously into the DVD, as well. Here, the word “simultaneous recording” does not mean automatic recording of data into another medium successively after completion of recording of the data into a certain medium, as in backup processing of a file server or a mirror ring, but means concurrent, real-time recording of a single set of data into two mediums. The user operates a simultaneous record button of the operation section 24, whereupon processing can proceed to a simultaneous recording mode. When the record button is operated in succession to operation of the simultaneous record button, simultaneous recording is performed. Although data are recorded simultaneously into the HD and the DVD, the current drive is still present. Specifically, on the assumption that the current drive achieved before simultaneous recording operation is the HDD section 16, the HDD section 16 is still held as a current drive even after completion of simultaneous recording operation. Therefore, when playback is performed after completion of simultaneous recording operation, a file in the HD is selected unless the current drive is changed.

When simultaneous recording is performed, the same music data are stored as the BWF in the respective project directories (hereinafter abbreviated simply as “projects”) in the HD and the DVD. Accordingly, the two projects stored simultaneously when simultaneous recording is performed are taken as paired projects, and a correspondence between the paired projects is internally stored as paired project information, whereby operability achieved during simultaneous recording is enhanced to a much greater extent. Specifically, when simultaneous recording is performed, a project where the same music data are to be stored must be selected in each of the HD and the DVD. Even when simultaneous recording is again performed, the same procedures must be iterated. However, so long as paired project information is internally stored and projects where the same music data are to be stored are automatically selected by reference to the paired project information when simultaneous recording is again performed, the user can save efforts required to again select projects and becomes able to perform simultaneous recording through simple operation analogous to that performed when individual recording is performed. For instance, when the current drive is the HDD section 16 and when certain music data are simultaneously recorded, the user selects as a destination a certain project in the HDD section 16 that is the current drive, whereupon the microcomputer section 22 locates a paired project in the DVD (pairing up with) corresponding to the project in the selected HD by reference to the paired project information in the HD and issues an instruction to the signal processing section 12. The user only selects a project in the HD and does not need to select its counterpart project in the DVD.

The essential requirement is to create paired project information as; for example, a file in the HD, and store in an associated manner designations of directories constituting the two projects.

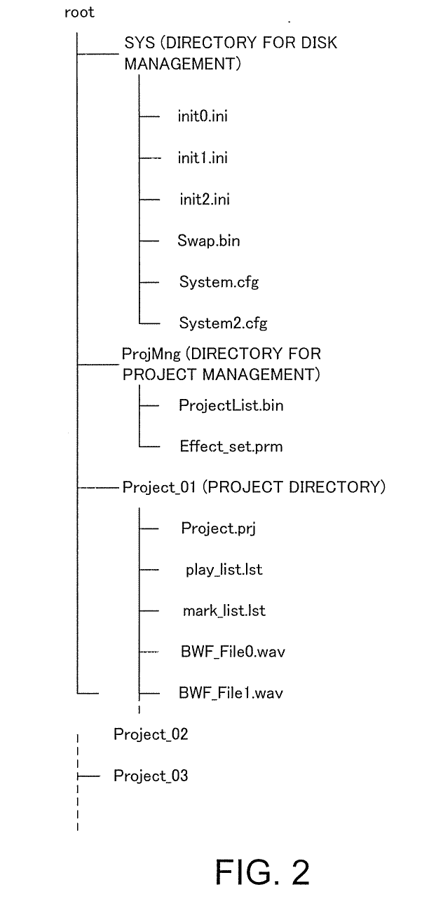

FIG. 2 shows an example structure of directories in the HD. A system directory SYS, a project management directory ProMng, a project directory (project) Project 01, 02, 03, . . . , are present at a level below the root directory. Of the projects, Project.prj designates setting data pertaining to the project; play_list.lst designates playlist information in the project; mark_list.lst designates mark list data in the project; and BWE_File0.wav, and the like, is a file main body of a BWF. Similar directories are created in the DVD, too. For instance, correspondence between Project 1 in the HD and Project 0 in the DVD (HD, DVD)=(Project 1, Project 0) is stored as paired project information in the HD.

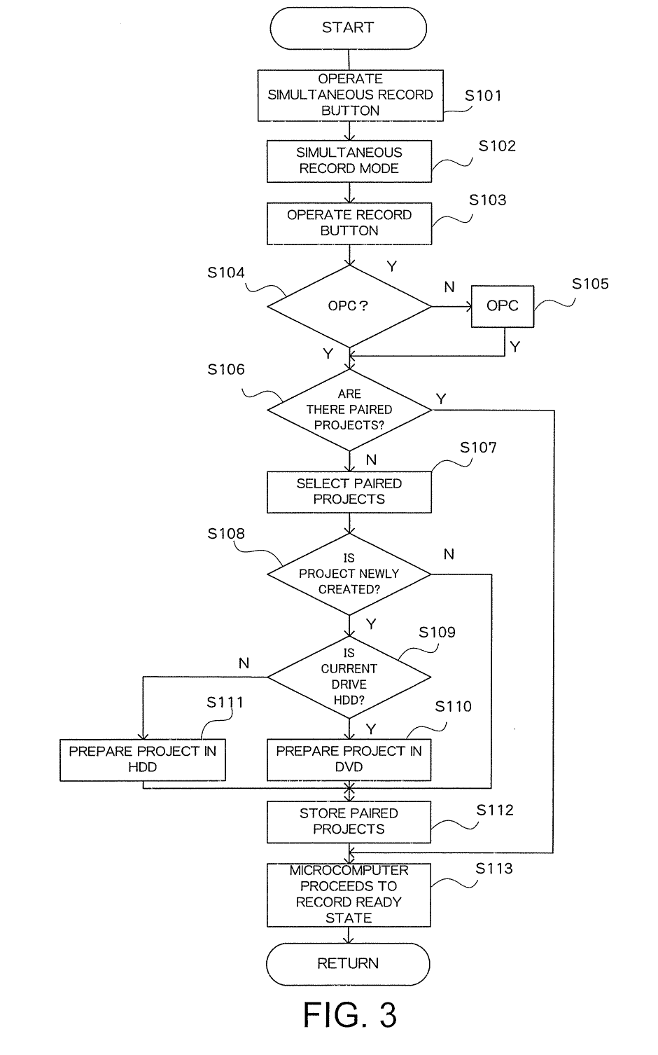

FIGS. 3 through 5 show processing flowcharts of the present embodiment. FIG. 3 is processing performed when the record button is performed in succession to the simultaneous record button. The user first operates the simultaneous record button of the operation section 24 (S101). In response to operation of the simultaneous record button, the microcomputer section 22 proceeds to a simultaneous recording mode (S102). Next, when the user operates the record button (S103), simultaneous record processing is performed. During simultaneous record processing, music data are recorded in the HD and the DVD, and the DVD must be in a data-recordable state. When data are recorded in the DVD, OPC (Optimum Power Control) processing for optimizing recording power is required, and a determination is made as to whether or not recording power is optimized as a result of OPC processing having already been performed (S104). When recording power is not optimized, the microcomputer section 22 instructs the optical disk drive section 14 to perform OPC (S105) The optical disk drive section 14 writes test data, for a try, in a test area (PCA) previously formed along an inner radius of the DVD by changing recording power in a stepwise manner. The thus-written test data are reproduced, and the quality of a reproduced signal; for example, a β value, a γ value, the degree of modulation, and the like, is measured, and recording power at which desired quality is achieved is selected.

After the DVD has become data recordable as a result of completion of OPC, a determination is made as to whether or not paired project information is present (S106). In the case of the first simultaneous recording operation, paired project information is not yet created, and hence NO is provided as a determination. In this case, processing provided below is performed.

Specifically, the user first selects from the HD and the DVD projects that are to serve as paired projects. When the current drive is the HDD section 16, a project is first selected from the HD, and another project is selected from the DVD. When the projects are selected from the existing projects in both the HD and the DVD, the thus-selected projects are considered to have been selected as paired projects by the user. The microcomputer section 22 takes the two projects as paired projects, and stores, as a file in the HD, paired project information for associating the two projects with each other (S112).

In the meantime, there is also a case where the user desires to record music data into a new project rather than into an existing project. In this case, a project is newly created (YES in S108). When the current drive is the HDD section 16, a new project is created in the DVD (S109 and S110). When the current drive is not the HDD section 16, a new project is created in the HD (S109 and S111). The project for which the current drive has been selected and a newly-created project in the non-current drive are taken as a paired project, and paired project information for associating the two projects is stored in the HD (S112). As a matter of course, the new project in the current drive and the new project in the noncurrent drive can also be taken as a paired project. The microcomputer section 22 automatically considers the projects selected by the user as a project constituting a paired project and creates paired project information. After preparation of the paired project information, the microcomputer section 22 proceeds to a record ready state (S113).

In the meantime, when the paired project information is determined to be present in S106; namely, when the current recording is determined to be second simultaneous recording or subsequent simultaneous recording, processing pertaining to S107 to S112 for creating paired project information is not necessary, and the microcomputer section immediately proceeds to the record ready state (S113). The microcomputer section 22 can immediately locate a project to be subjected to simultaneous recording by reference to the paired project information stored in the HD. In this case, the essential requirement for the user is to merely select the project in the current drive, and the user does not need to select the project in the non-current drive. The microcomputer section 22 can automatically locate the project in the non-current drive by use of the paired project information, whereby operation becomes identical to that performed in the case of the individual recording mode. Specifically, in the case of the individual recording mode, the essential requirement for the user is to merely select a project in the current drive. However, in the present embodiment, the project in the non-current drive is automatically located by use of the paired project information even in the case of the simultaneous recording mode. Hence, the essential requirement for the user is to select the project in the current drive, so that the user's operability is considerably enhanced. It can also be said that the user does not need to have a particular awareness of the fact that the current mode is the simultaneous recording mode. Now, the record ready state is a state where recording can be commenced and a standby state where recording is commenced by means of taking operation of the play button as a trigger.

Even in the individual recording mode rather than the simultaneous recording mode, when the record button is operated, the microcomputer 22 proceeds to the record ready state, and recording is commenced while subsequent operation of the play button is taken as a trigger.

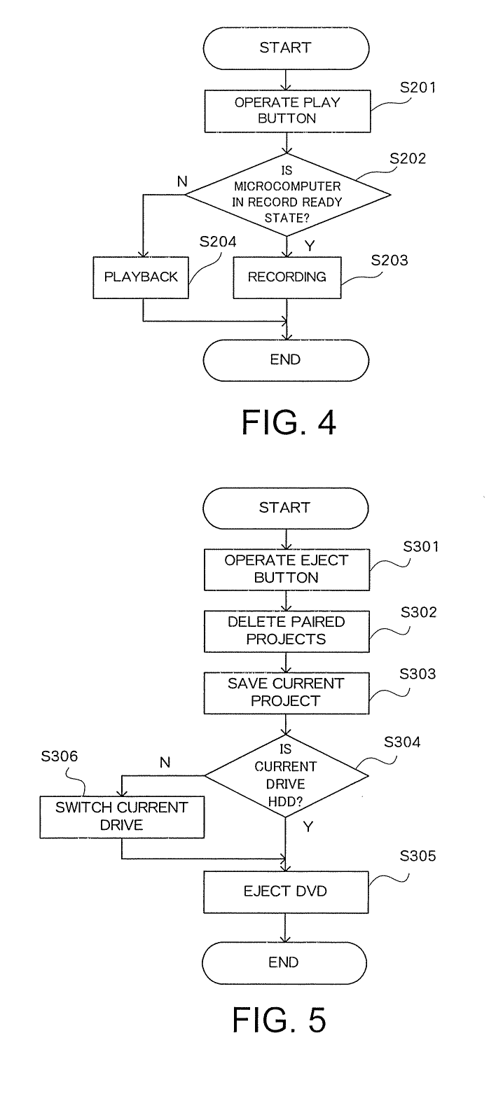

FIG. 4 shows processing performed when, after operation of the simultaneous record button and the record button, the play button is further operated. When the user operates the play button of the operation section 24 (S201), a determination is made as to whether or not the microcomputer section 22 is in a record ready state (S202). When the microcomputer section 22 is in the record ready state, the microcomputer section 22 instructs the signal processing section 12 and to record data simultaneously into the HD and the DVD (S203) In this case, the same music data are stored in the form of a file of a BWF into the project located by the paired project information stored in the HD. Specifically, when the paired project information is (HD, DVD)=(Project 2, Project 1), the same music data are stored in Project 2 of the HD and Project 1 of the DVD. In the meantime, when not in the record ready state, the microcomputer section 22 plays music data selected from the current drive (S204).

FIG. 5 shows processing performed when an eject button has been operated. When the user operates the eject button of the operation section 24 (S301), the microcomputer section 22 deletes the paired project information stored in the HD (S302). When the current project of the DVD is saved (S303) and when the current drive is the HDD section 16, the DVD is ejected (S304, S305). When the current drive is not the HDD section 16, the DVD is ejected after switching of the current drive to the HDD section 16 (S304, S306) (S305). As mentioned above, the paired project information is deleted at the time of ejection of the DVD. The reason for this is that, when a new DVD is inserted, the paired project information becomes erroneous information. The paired project information is stored in the HD and hence is not deleted even when the power of the data recorder is turned off. As a matter of course, when the once-ejected DVD is inserted again, the paired project information can be utilized again. Therefore, information about identification of an inserted/ejected DVD is held in the HD, and paired project information is stored in conjunction with the information about the identification of the DVD. The paired project information may be held, as-is, in spite of ejection of the DVD. When a DVD is inserted, the paired project information corresponding to the DVD may also be retrieved and utilized.

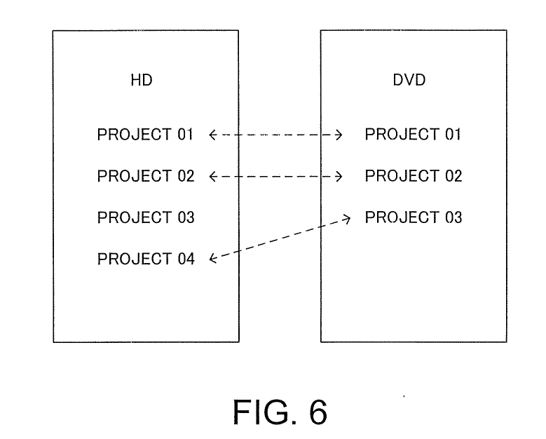

The paired project information is arbitrary in the present embodiment and can be stored as a map that defines correspondence. FIG. 6 shows an example map defining paired project information. The drawing illustrates that a project 01 in the HD is associated with a project 01 in the DVD; that a project 02 in the HD is associated with a project 02 in the DVD; and that a project 04 in the HD is associated with a project 03 in the DVD. When the project 04 in the HD is selected in the simultaneous recording mode, the project 03 in the DVD is automatically set, and the same music data are stored. The project 03 in the HD is one for which paired projects have not been created because data are recorded in; for example, an individual recording mode.

As is seen from FIG. 6, on the assumption that the current drive is the HD, it is understood that the directory in the DVD is automatically determined in the simultaneous recording mode by means of selection of a directory in the HD. For instance, when the project 02 in the HD is selected, the project 02 in the DVD is automatically determined. When the project 04 in the HD is selected, the project 03 in the DVD is automatically determined. A difference between the automatic determination of a counterpart project in the DVD and a mirror ring of a built-in HD in a file server or a computer is obvious.

Although the present embodiment illustrates the HD as a built-in medium and a DVD as a portable medium, the present invention is not limited to these examples. For instance, flash memory may also be used as the built-in medium, and flash memory or an optical disk, such as a BD (Blu-ray disk), may also be used as the portable medium.

Moreover, in the present embodiment, paired project information is stored as relevant information in the HD. However, the information may also be stored in volatile or nonvolatile memory in the microcomputer section 22. When the paired project information is stored in volatile memory, the paired project information disappears when the power of the data recorder is turned off. Alternatively, the paired project information serving as relevant information can also be stored in the DVD. For instance, the paired project information is stored as one piece of set data in a Project.prj directory in a DVD, and the like. In the case of the simultaneous recording mode, the microcomputer section 22 instructs the optical disk drive section 14 to read paired project information from the directory of the DVD, thereby locating a project in the DVD corresponding to the selected project in the HD. The paired project information serving as relevant information may also be stored in either a built-in medium or a portable medium. When paired project information is stored in the portable medium, attention must be paid to a limitation on the number of rewriting operations.

Although the present embodiment has described the data recorder having the optical disk drive section 14 and the HDD section 16, the present invention can also be applied to a case where a total of three recorder or more, including a built-in medium recorder and a portable medium recorder in combination, are provided. In this case, the essential requirement is to store directories of three or more mediums as paired directory information while the directories are associated with each other. For instance, when another optical disk drive section is present in the configuration shown in FIG. 1, a directory in a HD and directories of two DVDs are associated with each other. It is preferable to establish a star-shaped link by means of associating directories in other non-current drives with each other while the directory of the current drive is taken as a core directory. As a matter of course, the three directories may also be associated with each other in a cascaded manner.

Moreover, in the present embodiment, the directory in the HD and the directory in the DVD are associated with each other. However, objects of association are not always limited to the directories. Arbitrary storage areas in the HD and the DVD may also be associated with each other. In short, a unit of storage of data is not per directory but may also be arbitrary. For example, it may also be possible to store all sets of data into a single directory; prepare project-specific management tables; and make, at the time of new recording operation, settings pertaining to which one of the management tables is used for registering data in synchronism with selection of a target project.

What is claimed is:

1. A data recorder comprising:
a built-in medium recorder that records data in a built-in medium;
a portable medium recorder that records data in a portable medium;
a control section that has an individual recording mode for independently recording data in the built-in medium and the portable medium and a simultaneous recording mode for simultaneously recording identical data in the built-in medium and the portable medium and that controls the built-in medium recorder and the portable medium recorder in such a way that data are recorded in either of the modes in accordance with a selection instruction; and
a storage section that stores relevance information for associating with each other, among areas in the built-in medium and areas in the portable medium, areas where data are to be recorded simultaneously, wherein,
when the simultaneous recording mode is instructed, the control section locates areas in the built-in medium and the portable medium where data are to be simultaneously recorded, by use of the relevance information stored in the storage section and controls the built-in medium recorder and the portable medium recorder so as to simultaneously record data in the thus-located areas.

2. The data recorder according to claim 1, wherein, when the simultaneous recording mode is instructed, the control section locates directories in the built-in medium and the portable medium where data are to be recorded simultaneously, by use of the relevance information stored in the storage section.

3. The data recorder according to claim 2, wherein the storage section stores, as the relevance information, information for associating a directory in the built-in medium with a directory in the portable medium, which have been selected in the first simultaneous recording mode for the built-in medium and the portable medium; and
the control section locates directories where data are to be recorded simultaneously by use of the relevance information in the case of a second simultaneous recording mode or a subsequent simultaneous recording mode for the built-in medium and the portable medium.

4. The data recorder according to claim 3, wherein, in a second simultaneous recording mode or a subsequent simultaneous recording mode for the built-in medium and the portable medium, the control section automatically locates a directory in another medium where data are to be recorded simultaneously, by use of the relevance information, when either the directory in the built-in medium or the directory in the portable medium is selected, thereby obviating a necessity for selecting a directory in a remaining medium and making operation identical with that performed in the individual recording mode.

5. The data recorder according to claim 1, wherein the relevance information is deleted as a result of ejection of the portable medium.

6. The data recorder according to claim 1, wherein the relevance information is recorded in the built-in medium.

7. The data recorder according to claim 1, wherein the built-in medium is a hard disk, and the portable medium is an optical disk.

8. A data recorder comprising:
a hard disk drive that records data in a hard disk;
an optical disk drive that records data in an optical disk; and
a control section that controls the hard disk drive and the optical disk drive so as to simultaneously record data in the hard disk and the optical disk, wherein, when second simultaneous recording or subsequent simultaneous recording for the hard disk and the optical disk is performed, the control section automatically sets an area in the hard disk and an area in the optical disk where data are to be recorded simultaneously, by use of relevance information that associates the area in the hard disk with the area in the optical disk and that has been selected at the time of performance of first simultaneous recording for the hard disk and the optical disk.

9. The data recorder according to claim 8, wherein the relevance information is stored in the hard disk or the optical disk.

10. The data recorder according to claim 8, further comprising:
a volatile or nonvolatile storage section for storing the relevance information.
